(19) United States
(12) Patent Application Publication
(10) Pub. No.: US 2023/0267398 A1
(43) Pub. Date: Aug. 24, 2023

(54) ONLINE CUSTOMER INQUIRY TOOL WITH RESPONSE TIME MEASUREMENT

(71) Applicants: Justin R Haul, Pensacola, FL (US); Phillip L Infinger, Pensacola, FL (US)

(72) Inventors: Justin R Haul, Pensacola, FL (US); Phillip L Infinger, Pensacola, FL (US)

(21) Appl. No.: 17/876,890

(22) Filed: Jul. 29, 2022

Related U.S. Application Data
(60) Provisional application No. 63/312,647, filed on Feb. 22, 2022.

(51) Int. Cl. G06Q 10/06

(52) U.S. Cl. CPC G06Q 10/06393; G06Q 10/0633

(57) ABSTRACT

Systems and methods for automatically inquiring about becoming an online customer and measuring response times for calls, voicemails, emails, and texts.

### CROSS-REFERENCE TO RELATED APPLICATIONS

The present application claims priority to U.S. Provisional Application No. 63/312,647 filed Feb. 22, 2022, titled “ONLINE CUSTOMER INQUIRY TOOL WITH RESPONSE TIME MEASUREMENT,” which is hereby incorporated by reference in its entirety.

### TECHNICAL FIELD

The present disclosure relates to systems, methods, and apparatuses for automatically inquiring about becoming an online customer and measuring response times for calls, voicemails, emails, and texts.

### BACKGROUND

In the past, tracking business gaps in lead management and business response time has been performed manually by internal and external quality assurance people and groups, sometimes known as “secret shoppers.” This has often entailed a tedious and time-consuming process, itself prone to errors that can in turn lead to erroneous analyses due to faulty underlying data and assumptions.

For the foregoing reasons, there is a need for semi-automated and fully automated lead management and business response time, which can ensure a higher degree of accuracy in reporting and time measurement and better business management decisions.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In various embodiments, tools are provided that show gaps in lead management and response times for businesses. In some embodiments these tools act as a “customer,” request an appointment, consultation, and/or additional information through a client's website and measure the responsiveness of the business in contacting the “customer.” Various metrics can be used to measure responsiveness, including email, text message, voice and/or video calls, and voicemails. Reports with grades can then be generated based on KPIs set in a campaign for each touchpoint type (email, text message, calls, and voicemails). If the business fails the KPIs that were set, the system can display or link to resources to improve effectiveness, such as documents, videos, and/or other tutorials or information. These can be customized based on the KPI(s) that was(/were) failed.

Advantages gained through implementation of the systems and methods disclosed herein include better measurement of employee productivity and more accurate comparison with metrics, particularly in the areas of lead follow-up, contacting, and converting prospective customers into sales. Increased accuracy of job performance analysis can lead to improved efficiency, higher sales numbers, better customer service, and better identification and remedies for problem areas for the business and a more effective allocation of resources.

The configuration of the devices described herein in detail are only example embodiments and should not be considered limiting. Other systems, devices, methods, features, and advantages will be or will become apparent to one with skill in the art upon examination of the following figures and detailed description. It is intended that all such systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof. Moreover, all illustrations are intended to convey concepts, where relative sizes, shapes, and other detailed attributes may be illustrated schematically rather than literally or precisely.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a computer system, in accordance with some embodiments described herein;

FIG. 2 is a campaign setting screen, in accordance with some embodiments described herein;

FIG. 3 is a KPI screen, in accordance with some embodiments described herein;

FIG. 4 is a resource screen, in accordance with some embodiments described herein;

FIG. 5 is a report card, in accordance with some embodiments described herein;

FIG. 6 is a report card, in accordance with some embodiments described herein;

FIG. 7 shows an example embodiment of a prospect mode prospect list screen;

FIG. 8 shows an example embodiment of a prospect mode prospect map screen;

FIG. 9 shows an example embodiment of a prospect mode location screen;

FIG. 10 shows an example embodiment of a prospect mode details screen;

FIG. 11 shows an example embodiment of a prospect mode confirmation screen;

FIG. 12 shows an example embodiment of a prospect mode lead entry screen;

FIG. 13 shows an example embodiment of a prospect mode lead entry screen;

FIG. 14 shows an example embodiment of a client mode flowchart; and

FIG. 15 shows an example embodiment of a prospect mode flowchart.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Reference will now be made in detail to the present preferred embodiment(s), and examples of which is/are illustrated in the accompanying drawings. Whenever possible, the same reference numerals will be used throughout the drawings to refer to the same or like parts.

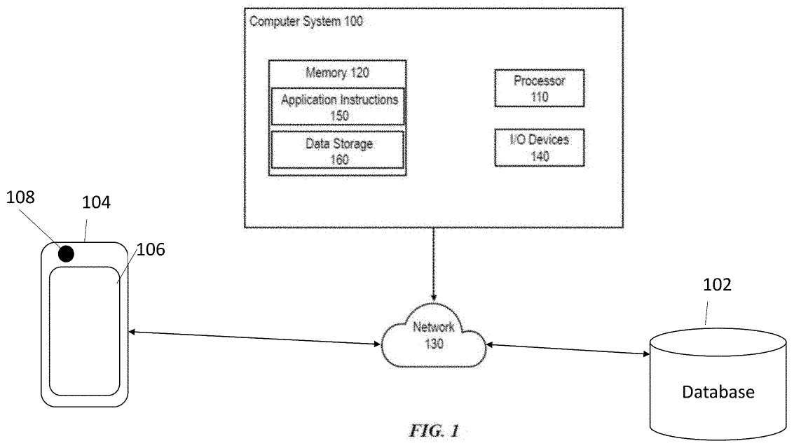

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

As shown in the example embodiment, a mobile computing device 104 can also be communicatively coupled with and exchange data with network 130. Those in the art will understand that mobile computing device 104 can include some or all of the same or similar components as computer system 102, coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g. a digital camera, scanner, or others) and associated structures and elements operatively coupled to at least one processor and memory of the mobile computing device. Mobile computing device 104 can also be supplemented or replaced with a desktop computing device in some embodiments.

Also shown in FIG. 1 are one or more database(s) 102. These databases can be locally stored in memory or remotely stored in memory that is accessible by computer system 100 via network 130 and may be proprietary, public, or some combination thereof. These databases can also be third-party or system databases in some embodiments and may have one of any manner of structures, privacy measures, and other features and elements. Marketing database(s) can include marketing information that the system 100 stores, uses, makes accessible, and/or sends to users via the network 130. Database(s) can include profiles for users, report cards, and/or other information and can include saved payment information, statistical data, preferences, and other information for use by computer system 100.

The embodiments described herein contemplate secret shopping of system partners as well as prospects. It can be operable to reach out to or otherwise contact the office/business via a web form, submit information, and then measures response times. All of these actions can be performed in order to evaluate strengths and weaknesses and assist in improving Lead Response Management for businesses.

During operation the system can reach out to a business via a webform. The business may then enter any requested information into the webform and/or otherwise reply to the inquiry. Thereafter, the system can measure a response time between the time the webform was initially sent and the time the response is received from the business. One or more metrics can be set to evaluate the performance, including response time and/or other follow-up time lengths over a series of telephone calls, emails, text messages, instant messages, audio messages, video messages, pages, and/or other communications.

The embodiments described herein provide for a process that can be used to measure the business's and/or competitor's response time to a prospect or customer inquiry. In some embodiments, there are multiple methods included in system software that allows users to perform this measuring depending on whether a customer or prospect is the target being evaluated.

A first mode can be a prospect mode. In the process mode, the software code stored in non-transitory memory can cause a processor of the system to generate identifier information. This prospect identifier information can include one or more of a unique name, email address, physical address, social media profile or handle, phone number, and/or many others. The system can take this prospect identifier information and identify and enter the information into appropriate fields and/or forms in a prospect's contact form on a website. Once entered, the form can be submitted and the system can log temporal information such as a time and date and associate it with the prospect identifier information in non-transitory computer readable memory such as a database of a server. The system can then monitor any traffic that is sent from the prospect and received at the system or associated dummy or proxy contact location (e.g. phone call at number, SMS, or email to account). This traffic can be used to generate a report card that grades the response or follow-up based on one or more predefined system metrics, such as length of time required for response or other timeliness. Such grading can occur as the result of comparing a time or other value to a threshold, range, or other numerical metric along a scale or other chart or graph.

Another mode provided by the system can be customer mode. In customer mode, the system can setup or otherwise run one or more campaigns, based on how often a user or subscribe wants to run a “secret shop” operation on a particular customer. In some embodiments this may be as infrequent as a single secret shop. Alternatively, the system may set a recurring secret shop operation that functions on a regular (e.g. weekly, monthly, quarterly, etc.) or irregular (e.g. on a Tuesday morning, a subsequent Thursday evening, and a fortnight later on a Friday at noon) schedule, depending on user desires. Additional functionality includes the ability to select a time that a secret shop operation occurs (e.g. morning, afternoon, after hours, weekend, etc.).

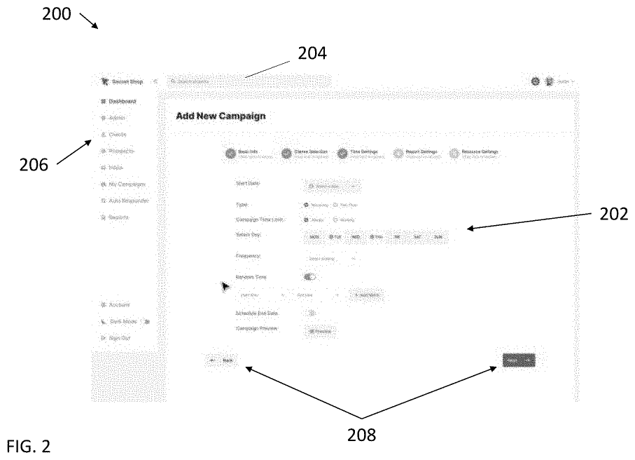

FIG. 2 shows an example embodiment of a campaign setting screen 200. As shown in the example embodiment, a system user or administrator can customize a number of campaign variables 202. This can include Basic info, Clients Selection, Time Settings, Report Settings, and Resource Settings. A start date can be selected from a calendar or entered in a field. A campaign type can be selected from one or more options, such as recurring or one-time in the form of radio buttons or otherwise. Similarly, a campaign time limit can be selected from one or more options, such as weekly, monthly, or otherwise. Days of the week for campaign actions can be set, in addition to frequency, randomization, start time, end time, scheduled end dates, campaign previews, and others. Secret shop projects can be searched by entering search term(s) in a search field 204. Menu 206 includes selectable buttons that can cause the display of tabs, windows, or screens for a dashboard, admin, clients, prospects, inbox, my campaigns, auto responder, reports, account, dark mode, and sign out. Navigation buttons 208 allow users to move to the next step or screen or back a step or screen.

In various embodiments the user can set up a campaign with KPIs and condition resources that show if a KPI is true or false. KPIs can be set on phones, email addresses, or SMS messages based on time or count.

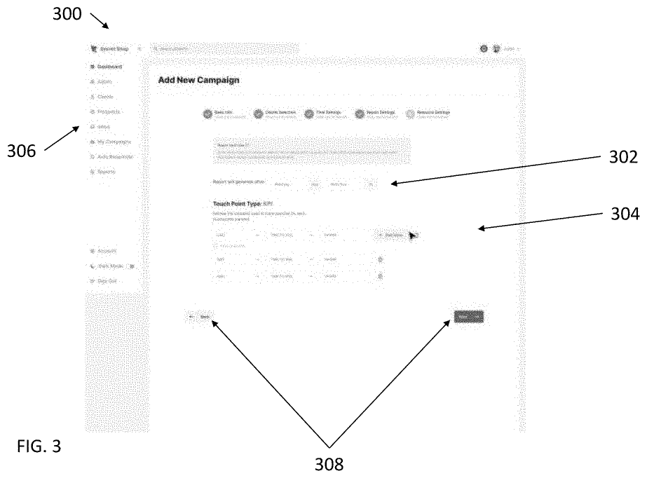

FIG. 3 shows an example embodiment of a KPI screen 300. As shown in the example embodiment, report card rules 302 can be displayed by the system, and report card generation dates and times can be set by a user. Touch Point Type KPI information 304 that is included can be calls, time to call, SMSs, time to SMS, email, time to email, and others, as appropriate.

An example of KPI information can be: First phone call within five minutes and voicemail left, second phone call within two hours and voicemail left, third phone call within twenty-five hours and voicemail left, first SMS within twenty-four hours, second SMS within forty-eight hours, third SMS within seventy-two hours, first email within twenty-four hours, second email within forty-eight hours, third email within seventy-two hours, phone call count equals three, SMS count equals three, email count equals three, for a total touchpoints amount of twelve (i.e. three phone, three SMS, three email, three voicemail, summed). The system can then display a resource utilization based on whether the KPIs are hit or missed. For example, if a call KPI is failed or missed, the system can display an information resource, such as an article or video, about the importance of touching or otherwise contacting a lead “X” times over a period of “Y.”

Menu 306 includes selectable buttons that can cause the display of tabs, windows, or screens for a dashboard, admin, clients, prospects, inbox, my campaigns, auto responder, reports, account, dark mode, and sign out. Navigation buttons 308 allow users to move to the next step or screen or back a step or screen.

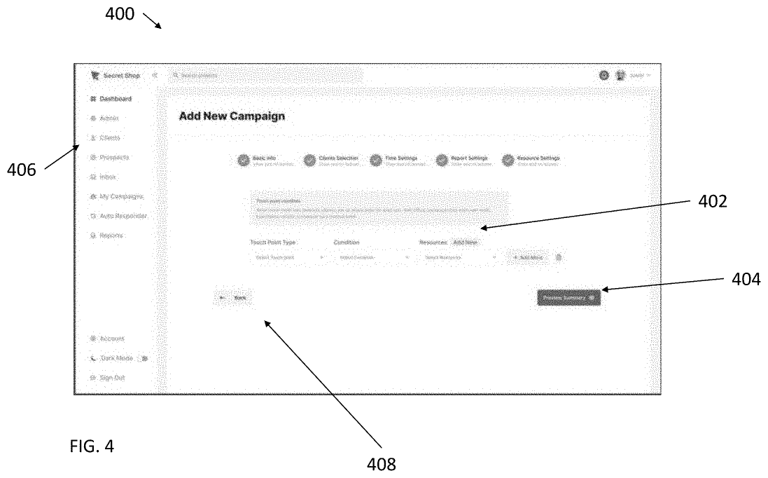

FIG. 4 shows an example embodiment of a resource screen 400. As shown in the example embodiment, users can select one or more campaign attributes 402 of a touch point type, a condition, resources, and/or others. A preview summary button 404 can execute an operation to perform, generate, and/or display a summary report. Menu 406 includes selectable buttons that can cause the display of tabs, windows, or screens for a dashboard, admin, clients, prospects, inbox, my campaigns, auto responder, reports, account, dark mode, and sign out. Navigation button 408 allows users to move back a step or screen.

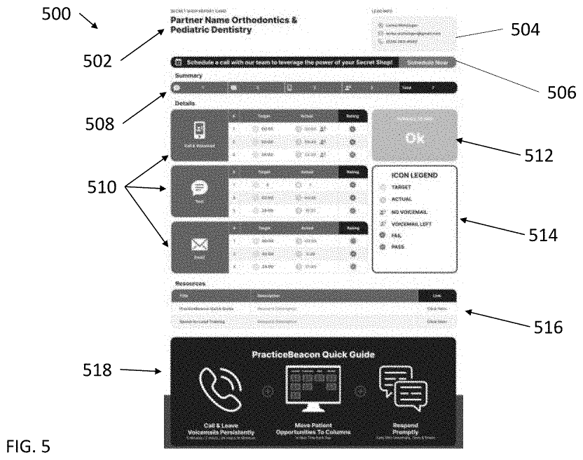

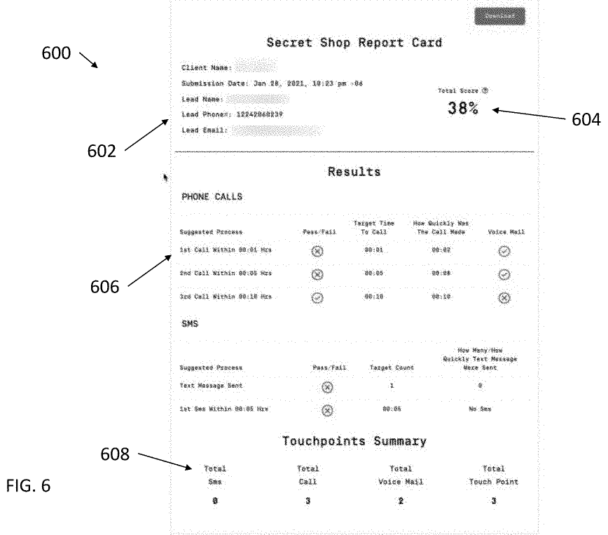

Once complete, the system can generate and display (and/or send for display) a report card, such as those in the example embodiments shown in FIGS. 5 and 6. As shown, contact information, temporal information, percentages, detailed results, summaries and totals, and other information can be display in a report. Reports can be used for a number of purposes, linked to particular individuals in the system, stored in association with information, and numerous others.

FIG. 5 is a digital report card 500, in accordance with some embodiments described herein. As shown in the example embodiment, an entity name 502 can be included and a particular lead may have a name, email, phone number, and/or other contact information 504 included for follow-up. Link(s) 506 can allow users to schedule additional appointments for secret shopping. A summary 508 can include the types of contact for a particular lead. For example, these can include messages, emails, phone calls, live discussions, and/or others, and can include numeric quantities and totals. Details fields 510 for each of call and voicemail, text, email, and others can include the number of targets, the amount of time spent in discussion, and ratings. An overall score 512 can also be included, as well as an icon legend 514 for embodiments where icons are used (e.g. target, actual, no voicemail, fail, pass, and/or others. Resources field 516 can include links to resources, such as training manuals, can also be provided, particularly for identified points that could benefit from improvement. Other forms of guides and tips 518 can also be included in the report card.

Thresholds for whether an overall score 512 can be user configurable in some embodiments. Users can control KPIs (e.g. count or time based metrics for phone calls, voicemails, SMS messages, emails, or others). Users can also control scoring metrics. Some or all scores can be based on percentages in some embodiments. Report card designs allow users to select or otherwise assign a word to particular values or ranges (e.g. “OK” for range 70-80%).

FIG. 6 is a digital report card 600, in accordance with some embodiments described herein. As shown in the example embodiment, a variety of report card information 602 can be included including client name, submission date, lead name, lead phone number, lead email, and/or others. Total score 604 can also be provided, as can a download button. Results for phone calls, SMS, and/or other communication means. Results information 606 included can be a variety of metrics, requirements, and grades. A summary 608 can include the quantity of touchpoints and their success.

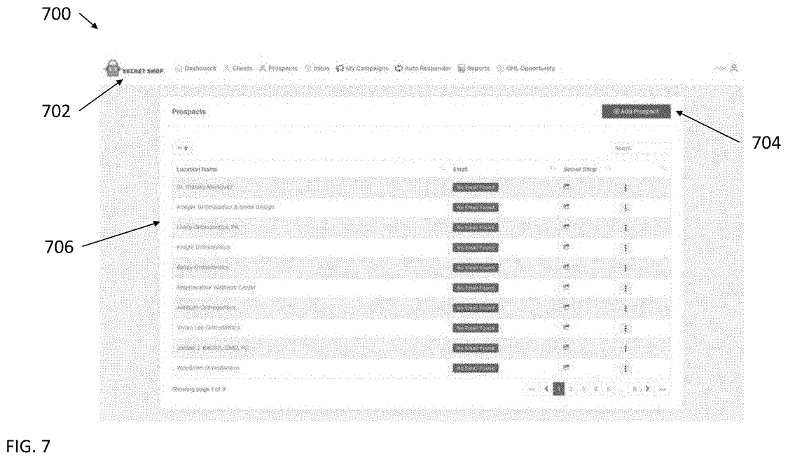

In various embodiments, the systems and methods disclosed herein can include a prospect mode with one or more features that allow system users to secret shop any business. This can be beneficial in that it can allow users to perform operations before sales calls or other calls. Prospect mode will be described with respect to example user interface screens as displayed in FIGS. 7-13.

As described with respect to FIG. 5, users are able to define KPIs of report cards. Scores can be calculated by a total number of KPIs divided by the number of successful attempts. For example, if KPIs are: First call within one minute plus voicemail equals two events; second call within five minutes plus voicemail equals two events; third phone call within ten minutes plus voicemail equals two events; total text count sent equals one, equals one event; and first SMS sent within five minutes equals one event. This is a total number of possible events to eight total possible events the evaluate could perform. If they perform eight out of eight they would score one hundred percent, while four out of eight would score fifty percent. In some embodiments a weighted scoring system where users can assign weighted values to each event can adjust how scores are calculated (i.e. some events will count for more than others based on weighting).

FIG. 7 shows an example embodiment of a prospect mode prospect list screen 700. As shown in the example embodiment, users can navigate the platform by selecting one or more menu buttons 702, including dashboard, clients, prospects, inbox, my campaigns, auto responder, reports, GHL opportunity, and/or others. An add prospect button 704 can be selected by a user, which will then display and/or allow users to create a prospect or add to a list of prospects. List of prospects 706 can included selectable prospect names, contact information such as email addresses, secret shop initiation button, additional information buttons, and page buttons.

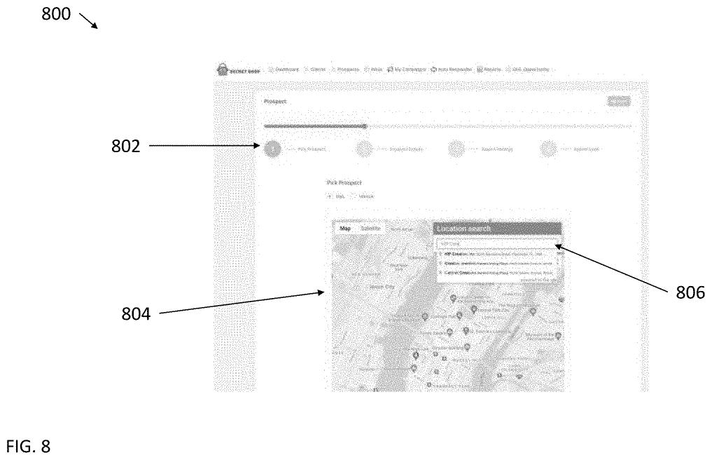

FIG. 8 shows an example embodiment of a prospect mode prospect map screen 800. As shown in the example embodiment, users can view and/or navigate a prospect order of operations bar 802 with at least one step, such as pick prospect, prospect details, report settings, submit lead, and/or others. A map 804 can be linked from a third-party mapping utility website or webpage or can be system based. Users can enter a location in a location field 806, which can then display location matches.

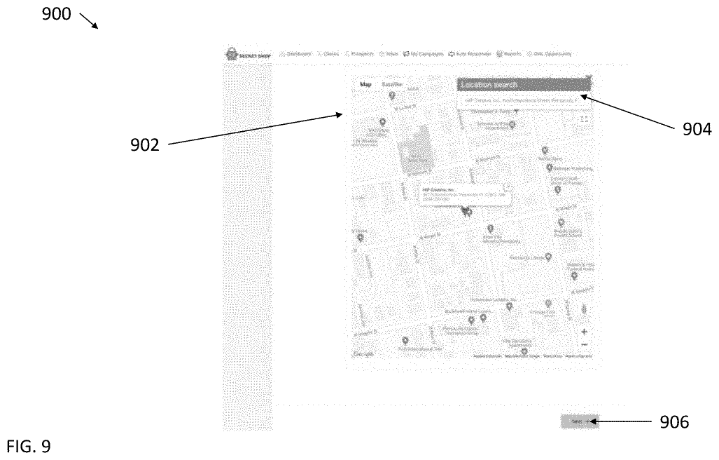

FIG. 9 shows an example embodiment of a prospect mode location screen 900. As shown in the example embodiment, a map 902 can show a particular location that a user may have searched for (e.g. on a prospect map screen as shown in FIG. 8). A location field 904 can allow users to enter and search for other locations. A next button 906 can allow users to navigate to a next display screen.

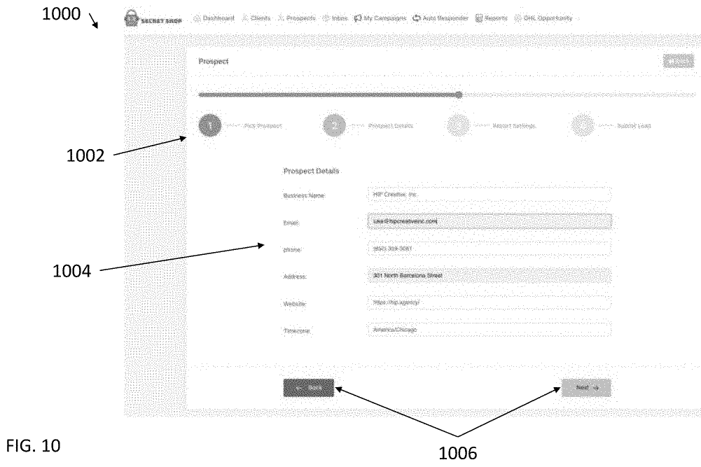

FIG. 10 shows an example embodiment of a prospect mode details screen 1000. As shown in the example embodiment, users can view and/or navigate a prospect order of operations bar 1002 with at least one step, such as pick prospect, prospect details, report settings, submit lead, and/or others. Prospect details fields can include a business name, email, phone, address, website, time zone, and/or other information fields that a user can fill in. Forward and back buttons 1006 can allow users to navigate to a next display screen or a previous display screen.

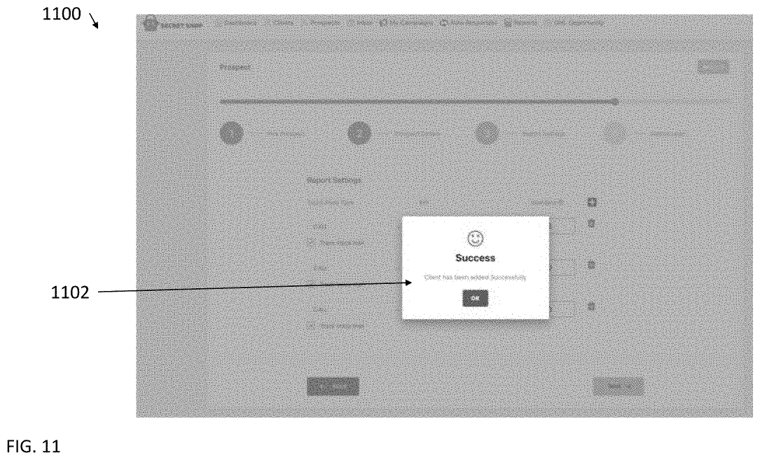

FIG. 11 shows an example embodiment of a prospect mode confirmation screen 1100. As shown in the example embodiment, once a user has entered a prospect's information, the system can display a confirmation message with a selectable affirmation button 1102.

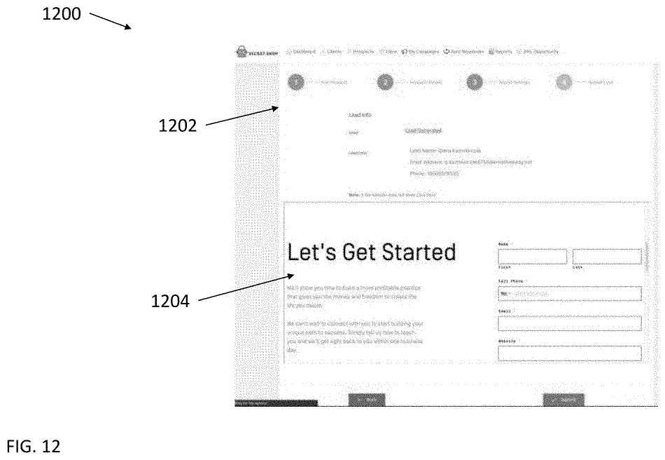

FIG. 12 shows an example embodiment of a prospect mode lead entry screen 1200. As shown in the example embodiment, lead information 1202 can include a lead name, lead information such as contact information, and others. A Let's Get Started section 1204 can allow users to sign up with the system by entering their contact information into specified fields such as name, cell phone, email, website, and/or others.

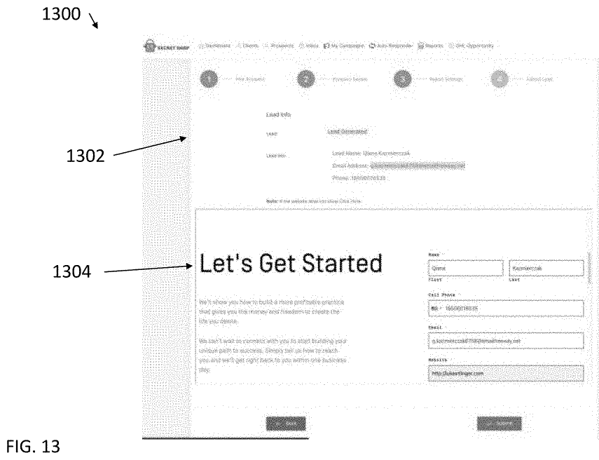

FIG. 13 shows an example embodiment of a prospect mode lead entry screen 1300 with information entered. As shown in the example embodiment, lead information 1302 can include a lead name, lead information such as contact information, and others. A Let's Get Started section 1304 can allow users to sign up with the system by entering their contact information into specified fields such as name, cell phone, email, website, and/or others.

In an example embodiment, a prospect can sign up with the system by accessing a system website. The system can then enter a prospect mode. When in prospect mode a “lead” can be generated by the system that includes information such as a name, tracking email address, tracking phone number, and/or others. Thereafter, an inquiry can be submitted on the subject website via a contact form, request appointment form, or other form. Next, the system can monitor all responses (e.g. calls, emails, SMS, instant message, or others) according to frequency, total, contact methods, and other metrics.

In some embodiments, if a prospect signs up with the system for secret shopping, many processes can require manual inputs. For example, a person navigate the system to a form, fill out the form, the system may alert the team, and the team may perform operations on the subject website. The system can then monitor any incoming contacts (e.g. calls, emails, SMS, and others) that are sent to a system leads contact monitor. The system may not contact the prospect, but the system is measuring the time and frequency of contacting the lead and grade the prospect based on the KPI that is set up by the user or team.

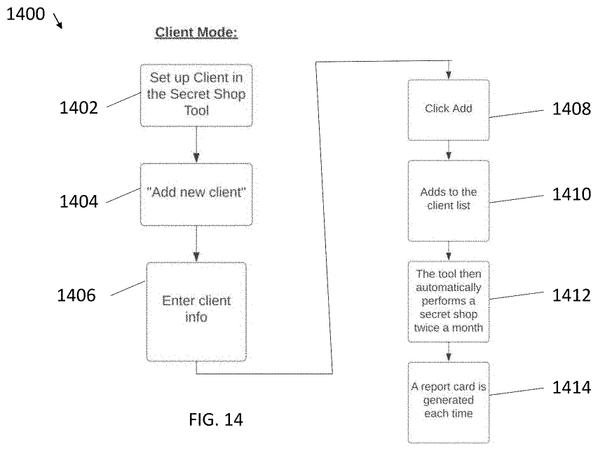

FIG. 14 shows an example embodiment of a client mode flowchart 1400. As shown in the example embodiment, an initial step 1402 can include setting up a client in a secret shop tool on the system platform. In step 1404, an add new client operation can be selectable and begin a client creation process when selected. Next, a user can enter client information such as contact information in step 1406. Once the information has been added, the user can select an add button in step 1408 and the client can be added to a client list in step 1410. Next, the system tool can automatically perform a secret shopping operation at user or system designated times and/or frequency (e.g. twice per month). In step 1414, after a secret shop operation has occurred, a report card can be generated in step 1414 and sent to or otherwise displayed to the client when they log into the system.

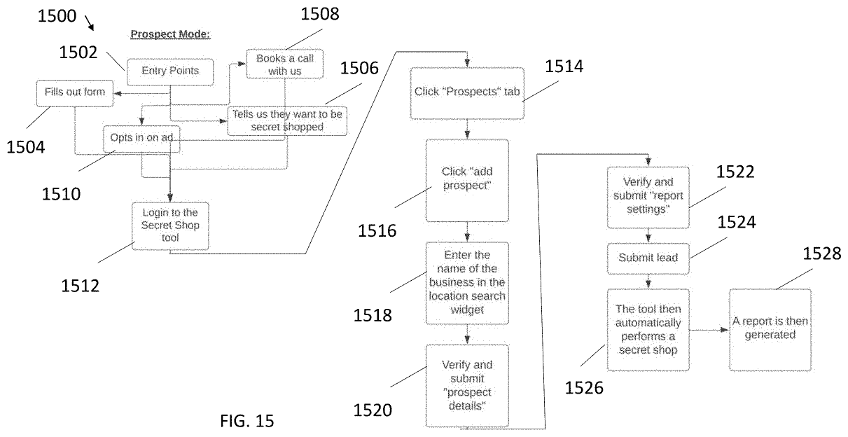

FIG. 15 shows an example embodiment of a prospect mode flowchart 1500. As shown in the example embodiment, a first step can include entry points 1502. From here, a client can fill out a form in step 1504, and then move to a login to the secret shop tool in step 1512. Alternately, a user can take an entry point 1502 to step 1506 to tell the system they want to be secretly shopped. This can lead to step 1512. Otherwise, 1502 can lead to opting in to a call in step 1510 or book a call in step 1508. These can each lead to step 1512. After step 1512, the system can move to a prospects tab upon user selection in step 1514. Users can then select an add prospect button in step 1516. Upon system prompt, the system can receive a business name and location and employ a search widget. Next, in step 1520, the system can verify and submit prospect details in appropriate fields as displayed by the system. Subsequently, the system can verify and submit report settings. Next, in step 1524 the user can submit a lead by selecting an appropriate button. The system tool can then automatically perform a secret shop operation in step 1526. Finally after a secret shop operation has occurred, a report card can be generated in step 1528 and sent to or otherwise displayed to the client when they log into the system.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method for using a computer system for business response time management, the method comprising:
a series of steps stored in non-transitory computer readable memory that, when executed by a computer processor, cause the processor to perform the steps of:
creating a client account for a business in response to a user entering business information relating to the business with the computer system;
performing at least one business response time determination function; and
generating a report based on at least one metric measured during the at least one business time determination function.

2. The method of claim 1, wherein the at least one business response time determination function is a secret shopper function.

3. The method of claim 2, wherein the secret shopper function measures the business' response time to a customer inquiry.

4. The method of claim 2, wherein the secret shopper function measures the business' response time to a prospect inquiry.

5. The method of claim 1, wherein the at least one business response time determination function is performed automatically.

6. The method of claim 1, wherein the at least one business response time determination function is performed manually.

7. The method of claim 1, wherein the at least one business response time determination function is based on at least two campaign variables.

8. The method of claim 7, wherein the campaign variables are selected from basic info, clients, time settings, report settings, and resource settings.

9. The method of claim 1, wherein the metric measured is a call follow-up KPI.

10. The method of claim 9, wherein an overall score is based on a user configurable threshold for KPIs.

11. A computer system for business response time management, comprising:
a client account stored in computer memory and for related business information;
a processor of the system operable to perform at least one business response time determination function; and
report generation based on at least one metric measured during the at least one business time determination function.

12. The system of claim 11, wherein the at least one business response time determination function is a secret shopper function.

13. The system of claim 12, wherein the secret shopper function measures the business' response time to a customer inquiry.

14. The system of claim 12, wherein the secret shopper function measures the business' response time to a prospect inquiry.

15. The system of claim 11, wherein the at least one business response time determination function is performed automatically.

16. The system of claim 11, wherein the at least one business response time determination function is performed manually.

17. The system of claim 11, wherein the at least one business response time determination function is based on at least two campaign variables.

18. The system of claim 17, wherein the campaign variables are selected from basic info, clients, time settings, report settings, and resource settings.

19. The system of claim 11, wherein the metric measured is a call follow-up KPI.

20. The system of claim 19, wherein an overall score is based on a user configurable threshold for KPIs.
